(19) United States
(12) Patent Application Publication
(10) Pub. No.: US 2025/0280458 A1
(43) Pub. Date: Sep. 4, 2025

(54) DEVICE CONNECTION METHOD, ELECTRONIC DEVICE AND COMPUTER PROGRAM PRODUCT

(71) Applicant: Lenovo (Beijing) Limited, Beijing (CN)

(72) Inventors: Xinquan LIU, Beijing (CN); Xiaojie MA, Beijing (CN); Tao YANG, Beijing (CN)

(21) Appl. No.: 19/064,147

(22) Filed: Feb. 26, 2025

(30) Foreign Application Priority Data
Feb. 29, 2024 (CN) 202410231911.9

(51) Int. Cl. H04W 76/15; H04W 4/80; H04W 76/14

(52) U.S. Cl. CPC H04W 76/15; H04W 4/80; H04W 76/14

(57) ABSTRACT

The present disclosure provides a device connection method, an electronic device, and a computer program product applied to a first electronic device. An example device connection method includes obtaining a first command, where the first command is used to request display of first device information required to establish a direct communication connection with the first electronic device; and determining that network device attributes of the first electronic device satisfy a target prerequisite, and displaying illustrative information containing second device information of a second electronic device, so that a third electronic device establishes a direct communication connection with the second electronic device based on the second device information, where the network device satisfying the target prerequisite indicates that the first electronic device has established a direct communication connection with the second electronic device.

### CROSS-REFERENCE TO RELATED APPLICATION

This application claims priority to Chinese Patent Application No. 202410231911.9, filed on Feb. 29, 2024, the content of which is incorporated herein by reference in its entirety.

### TECHNICAL FIELD

The present disclosure generally relates to the field of communication technology, and in particular to a device connection entity, an electronic device, and a computer program product.

### BACKGROUND

In order to improve the convenience of interaction between two electronic devices, a wireless direct connection technology such as wireless fidelity (Wi-Fi) direct may be used to establish a direct communication connection between the two electronic devices. The two devices that establish the wireless direct communication connection are in a direct connection group.

After two or more electronic devices have established a direct connection group based on wireless direct connection technology, if a user wants a new electronic device to join the direct connection group, the user needs to obtain the device information of the management terminal device in the direct connection group through the electronic device, so as to establish a direct communication connection with the management terminal device based on the device information of the management terminal device. However, the user does not know which electronic device in the direct connection group belongs to the management terminal device. Therefore, if the user uses a new electronic device to mistakenly obtain the device information of an electronic device that is a client terminal in the direct connection group, the new electronic device will not be able to establish a direct communication connection with the electronic device that is a client terminal based on the obtained device information, and naturally will not be able to join the direct connection group, resulting in a high complexity in establishing a direct communication connection between devices.

### SUMMARY

In one aspect, the disclosure provides a device connection method, applied to a first electronic device. The method includes obtaining a first command, where the first command is used to request display of first device information required to establish a direct communication connection with the first electronic device; and determining that network device attributes of the first electronic device satisfy a target prerequisite, and displaying illustrative information containing second device information of a second electronic device, so that a third electronic device establishes a direct communication connection with the second electronic device based on the second device information, where the network device satisfying the target prerequisite indicates that the first electronic device has established a direct communication connection with the second electronic device.

In some embodiments, the network device attributes of the first electronic device satisfying the target prerequisite include that, in the direct communication connection established between the first electronic device and the second electronic device, the first electronic device serves as a network client terminal and the second electronic device serves as a network management terminal.

In some embodiments, the method further includes obtaining the second device information of the second electronic device stored in the first electronic device, where the second device information is device information based on which the direct communication connection is established between the first electronic device and the second electronic device based on a short-distance communication protocol.

In some embodiments, the method further includes based on the direct communication connection established between the first electronic device and the second electronic device, obtaining, from the second electronic device, second device information currently required by the second electronic device to establish a direct communication connection with other electronic devices.

In some embodiments, the method further includes when the network device attributes do not satisfy the target prerequisite, displaying illustrative information containing just the first device information.

In some embodiments, the second device information in the illustrative information is encoded information, and the illustrative information includes a preset illustrative mark for indicating that the illustrative information includes the second device information.

In another aspect, the disclosure also provides another device connection method, applied to a third electronic device. The method includes, in response to a second command, scanning illustrative information displayed on a first electronic device; identifying second device information of a second electronic device included in the illustrative information; and based on the second device information, establishing a direct communication connection with the second electronic device, where the illustrative information is generated when network device attributes of the first electronic device satisfy a target prerequisite, and the network device attributes of the first electronic device satisfying the target prerequisite indicates that a direct communication connection has been established between the first electronic device and the second electronic device.

In another aspect, the disclosure further provides an electronic device, including at least one processor, a memory, and a display device. The at least one processor is configured to: obtain a first command, where the first command is used to request display of first device information required for establishing a direct communication connection with a first electronic device; determine that network device attributes of the first electronic device satisfy a target prerequisite; and display illustrative information containing second device information of a second electronic device through a display device, so that a third electronic device establishes a direct communication connection with the second electronic device based on the second device information, where the network device attributes satisfying the target prerequisite indicates that the first electronic device and the second electronic device have established a direct communication connection. The memory is configured to store programs required for the at least one processor to perform operations.

In some embodiments, the illustrative information includes first device information of the first electronic device and the second device information of the second electronic device; and identifying the second device information of the second electronic device included in the illustrative information includes identifying the second device information from the illustrative information.

In another aspect, the disclosure also provides a computer program product, including computer instructions, where the computer instructions are stored in a computer-readable storage medium, and when the computer program product is run on an electronic device, the computer program product is configured to execute any of the device connection methods described elsewhere herein.

### BRIEF DESCRIPTION OF THE DRAWINGS

In order to more clearly illustrate the technical solution in the embodiments of the present disclosure, the drawings essential for the description of the embodiments will be briefly described below. Apparently, the drawings described below are just some embodiments of the present disclosure. For a person skilled in the art, other drawings may be obtained based on the provided drawings without making creative efforts.

FIG. 1 illustrates a flowchart of a device connection method according to one embodiment of the present disclosure;

FIG. 2 illustrates an example application scenario in which a direct communication connection is established between electronic devices;

FIG. 3 illustrates a flow diagram of another device connection method according to one embodiment of the present disclosure;

FIG. 4 illustrates a flowchart of another device connection method according to one embodiment of the present disclosure;

FIG. 5 illustrates a schematic structural diagram of a device connection apparatus according to one embodiment of the present disclosure;

FIG. 6 illustrates a schematic structural diagram of another device connection apparatus according to one embodiment of the present disclosure; and

FIG. 7 illustrates a schematic diagram of a composition architecture of an electronic device according to one embodiment of the present disclosure.

### DETAILED DESCRIPTION

The technical solution in the embodiments of the present disclosure will be clearly and thoroughly described in combination with the accompanying drawings. Apparently, the described embodiments are just part of the embodiments of the present disclosure, rather than all of the embodiments. Based on the embodiments in the disclosure, all other embodiments obtained by a person skilled in the art without creative work are within the scope of protection of the present disclosure.

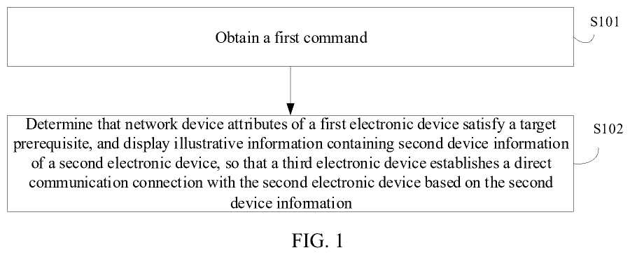

FIG. 1 illustrates a flowchart of a device connection method according to one embodiment of the present disclosure. The method in the illustrated embodiment may include the following steps.
S101: Obtain a first command.

The first command is used to request display of first device information required to establish a direct communication connection with the first electronic device.

In the present disclosure, a direct communication connection between two electronic devices refers to a direct connection between the two electronic devices without the aid of other intermediate devices. For example, a direct communication connection may be a point-to-point communication or wireless direct connection established between two electronic devices based on a short-range communication protocol (also called a short-distance communication protocol or a near-field communication protocol).

For example, a direct communication connection established between two electronic devices may be a Wi-Fi direct connection established based on the Wi-Fi direct connection technology, or a Bluetooth direct connection communication established based on the Bluetooth communication protocol. Apparently, the direct communication connection may also be a direct connection communication established based on other short-range communication protocols, which will not be described in detail here.

In one embodiment, the device information of an electronic device required to establish a direct communication connection with that electronic device may include at least one type of information required to establish a direct communication connection with that electronic device. For example, the device information may include part or all of the information such as the device name, the network name of the short-range wireless communication network required to establish the direct communication connection, and the connection password.

There may be many possible specific ways to obtain the first command, which are not limited in the disclosure.

For ease of understanding, an implementation method is used as an example: selecting “add a new device” option in the menu interface of a target application in an electronic device or selecting “add a direct communication device” option in the target function interface of an electronic device, and the like may trigger the electronic device to obtain the first command.
S102: Determine that network device attributes of the first electronic device satisfy the target prerequisite, and display illustrative information containing second device information of a second electronic device, so that a third electronic device establishes a direct communication connection with the second electronic device based on the second device information.

In one embodiment, the network device attributes of the first electronic device satisfying the target prerequisite at least indicate that a direct communication connection has been established between the first electronic device and the second electronic device.

The network device attributes of the first electronic device may include part or all of the information including the network protocol supported by the first electronic device, information related to the direct communication connection established by the first electronic device, and identity attribute information of the first electronic device in the direct communication connection, and so on.

In one embodiment, the direct communication connection established between the first electronic device and the second electronic device may be a direct communication connection based on a short-range communication protocol, such as a Wi-Fi direct connection established based on Wi-Fi direct connection technology, and the like as described earlier, details of which will not be repeated here.

Based on the above described device information, it can be seen that second device information of the second electronic device refers to the information required to establish a direct communication connection with the second electronic device. For example, the second device information may include at least one of the device name, network name, and password corresponding to the second electronic device for direct communication connection. For example, taking the Wi-Fi direct connection established between the first electronic device and the second electronic device based on the Wi-Fi direct communication protocol as an example, the second device information of the second electronic device may be the device name of the second electronic device, the network name and password of the Wi-Fi direct network provided by the second electronic device, and so on.

It is to be noted that, based on the direct communication connection technology of the short-range communication protocol, after a direct communication connection is established between two electronic devices, the two electronic devices actually form a direct communication network group.

In one embodiment, a first electronic device may provide second device information of a second electronic device with which a direct communication connection is established, so that other electronic devices may obtain the second device information of the second electronic device through the first electronic device. Thus, under the premise that other electronic devices cannot establish a direct communication connection with the first electronic device based on the first device information of the first electronic device, a direct communication connection may be established with the second electronic device through the second device information of the second electronic device provided by the first electronic device. The other devices may then join the direct communication network group where the first electronic device and the second electronic device are included.

In the present disclosure, the third electronic device may be any electronic device other than the first electronic device and the second electronic device, which is not limited here.

It is to be noted that, in one embodiment, if the network device attributes of the first electronic device do not satisfy the target prerequisite, the first electronic device may display illustrative information containing just the first device information.

The fact that the network device attributes of the first electronic device do not satisfy the target prerequisite may indicate that the first electronic device is still capable of establishing a direct communication connection with other electronic devices. For example, if the first electronic device does not currently have a direct communication connection with any second electronic device, then the first electronic device should be able to establish a direct communication connection with the third electronic device if the first electronic device supports the direct communication technology.

From the above descriptions, it can be seen that in the disclosure, after the first electronic device obtains the first command requesting to display the first device information used to establish a direct communication connection with the first electronic device, if the network device attributes of the first electronic device satisfy the target prerequisite, the first electronic device will display the second device information of the second electronic device with which the direct communication connection is established. It can be seen that, under the premise that the first electronic device and the second electronic device have established a direct communication connection, even if the first electronic device can no longer establish a direct communication connection with the third electronic device, since the third electronic device can obtain the second device information of the second electronic device through the first electronic device, the third electronic device can still establish a direct communication connection with the second electronic device based on the second device information of the second electronic device, and join the direct communication group where the first electronic device and the second electronic device are located. The user thus does not need to distinguish the network device attributes of the electronic devices that have established the direct communication connection. This sequentially avoids a situation where the user cannot join the direct communication group due to incorrect device information obtained by the electronic device for direct communication connection, and also reduces the complexity of establishing a direct communication connection between electronic devices.

In the disclosure, the displayed information may include just the second device information of the second electronic device. Apparently, the illustrative information may also include both first device information of the first electronic device and second device information of the second electronic device.

In the case where the illustrative information includes both the first device information and the second device information, the third electronic device obtains the first device information and the second device information based on the illustrative information. The third electronic device may respectively establish a direct communication connection with the first electronic device based on the first device information, and establish a direct communication connection with the second electronic device based on the second device information. If the first electronic device cannot establish a direct communication connection with the third electronic device when the first electronic device has established a direct communication connection with the second electronic device, then the third electronic device cannot successfully establish a direct communication connection with the first electronic device based on the first device information, but the third electronic device can still establish a direct communication connection with the second electronic device based on the second device information.

In one embodiment, when the illustrative information includes both the first device information and the second device information, the second device information in the illustrative information may also be associated with a high-priority indicator. The high priority indicator is used to indicate that the second device information is the device information of a second electronic device other than the first electronic device. For example, the high-priority indicator may be a specific sign associated with the second device information, which may have a specific color or other forms of sign, and the specific implementation is not limited here.

Based on this, the third electronic device may identify the second device information with a high priority indicator from the displayed information, and then the third electronic device may preferentially establish a direct communication connection with the second electronic device based on the second device information. After the third electronic device successfully establishes a direct communication connection with the second electronic device, there is no need to perform an operation of establishing a direct communication connection with the first electronic device based on the first device information.

In the embodiments described above, there may be many possible specific ways for the first electronic device to display the illustrative information, which is not limited in the disclosure.

In one embodiment, the second device information included in the illustrative information is encoded information. For example, the illustrative information may be presented in the form of a QR code. In this case, the user cannot directly read or tell that the second device information is not the device information of the first electronic device itself. In order to enable the user to understand that the illustrative information currently presented by the first electronic device includes device information that does not belong to the first electronic device, the illustrative information may also include a preset illustrative mark, which is used to inform that the illustrative information includes the second device information.

The preset illustrative mark may be the same as or different from the aforementioned high-priority indicator, which is not limited in the disclosure.

For example, the preset illustrative mark may be a target color presented by the second device information in the illustrative information, a designated frame surrounding the second device information, or other types of indicators, etc. Based on this, when the user sees information covered with the target color or surrounded by the designated frame in the displayed information, the user may determine that the displayed information includes the second device information of the second electronic device that has established a direct communication connection with the first electronic device.

In the disclosure, the network device attributes of the first electronic device satisfying the target prerequisite may indicate that the first electronic device is at risk of being unable to establish a direct communication connection with other electronic devices. For example, as long as the first electronic device has established a direct communication connection with the second electronic device, the first electronic device is at risk of being unable to establish a direct communication connection with other electronic devices other than the second electronic device.

In one embodiment, in order to improve the reliability of the third electronic device to successfully establish a direct communication connection with the second electronic device based on the second device information of the second electronic device included in the illustrative information, in the present disclosure, the illustrative information containing the second device information may be generated until it is confirmed that the first electronic device has established a direct communication connection with the second electronic device and the first electronic device cannot establish a direct communication connection with other electronic devices.

Correspondingly, the network device attributes of the first electronic device satisfying the target prerequisite may be: in the direct communication connection established between the first electronic device and the second electronic device, the first electronic device acts as a network client terminal, and the second electronic device acts as a network management terminal.

It is to be noted that there are differences in the specific protocol provisions of different short-distance communication protocols. In some short-distance communication protocols, when a direct communication connection is established between two electronic devices, one of the two electronic devices acts as a network client terminal and the other acts as a network management terminal. In such a scenario, an electronic device that acts as a network management terminal may establish a direct communication connection with multiple electronic devices. After an electronic device that acts as a network client terminal establishes a direct communication connection with the electronic device that acts as the network management terminal, the electronic device acting as the network client terminal may no longer establish a direct communication connection with other electronic devices based on the short-distance communication protocol.

Accordingly, if the first electronic device establishes a direct communication connection with the second electronic device, and in the direct communication connection, the first electronic device acts as a network client terminal, then the first electronic device cannot establish a direct communication connection with the third electronic device. Therefore, the third electronic device cannot establish a direct communication connection with the first electronic device based on the first device information of the first electronic device, and subsequentially cannot join the direct communication connection group where the first electronic device and the second electronic device are located.

In the direct communication connection established between the first electronic device and the second electronic device, if the first electronic device acts as a network client terminal, the illustrative information generated by the first electronic device may include the second device information of the second electronic device. After the third electronic device obtains the second device information from the illustrative information, the third electronic device may still establish a direct communication connection with the second electronic device based on the second device information, thereby allowing the third electronic device to also join the direct communication connection group, where the first electronic device and the second electronic device are located, as a network client terminal.

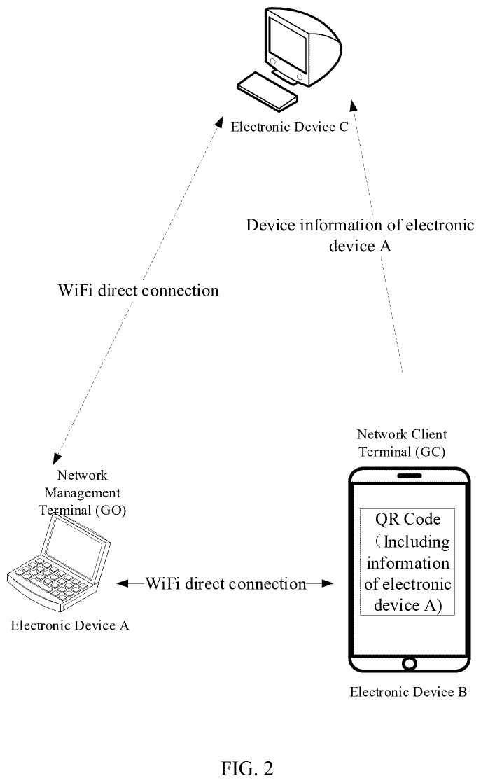

For ease of understanding, an application scenario of establishing a direct communication connection between electronic devices is taken as an example for explanation, as shown in FIG. 2.

For ease of description, a Wi-Fi direct connection based on the Wi-Fi direct protocol established between the electronic devices in FIG. 2 is taken as an example for explanation.

In FIG. 2, a Wi-Fi direct connection is established between electronic device A and electronic device B, and electronic device A and electronic device B form a Wi-Fi direct connection group based thereupon. Electronic device A is the network management terminal in the Wi-Fi direct connection, also known as the group owner (GO) in the Wi-Fi direct connection group, and electronic device B is the network client terminal of the Wi-Fi direct connection, also known as the group client (GC) in the Wi-Fi direct connection group.

Under such a scenario, electronic device B cannot establish a Wi-Fi direct connection with other electronic devices, but electronic device A, as the network management terminal, may still establish a Wi-Fi direct connection with other electronic devices. Therefore, if electronic device C wants to join the Wi-Fi direct connection group, electronic device C may just establish a Wi-Fi direct connection with electronic device A based on the device information of electronic device A in the Wi-Fi direct connection group.

However, the user cannot tell the network identity attributes of electronic device A and electronic device B, and thus cannot determine which device of electronic device A and electronic device B is the network management terminal. According to the existing technologies, after the user triggers electronic device B to display the device information of electronic device B itself in the Wi-Fi direct connection, electronic device C cannot establish a Wi-Fi direct connection with electronic device B based on the device information displayed by electronic device B, and thus cannot join the Wi-Fi direct connection group.

According to the present disclosure, if electronic device B detects a first command for requesting display of its device information for Wi-Fi direct connection, and realizes that it acts as a network client terminal in the Wi-Fi direct connection established with electronic device A, electronic device B may display the device information of electronic device A in the Wi-Fi direct connection.

As illustrated in FIG. 2, electronic device B may display a QR code containing the device information of electronic device A. Accordingly, electronic device C may obtain the device information of electronic device A from the QR code displayed by electronic device B, and establish a Wi-Fi direct connection with electronic device A based on the device information of electronic device A, so that electronic device C may join the Wi-Fi direct connection group, where electronic device A and electronic device B are located, as a network client terminal. Accordingly, electronic device B and electronic device C may exchange information with the assistance of electronic device A, and electronic device A may communicate directly with electronic device B and electronic device C.

It may be understood that the network device attributes of the first electronic device satisfying the target prerequisite may mean that: the first electronic device acts as a network client terminal in a direct communication connection with a second electronic device, and the second electronic device acts as a network management terminal. The network device attributes of the first electronic device not satisfying the target prerequisite may mean that: the first electronic device has not established a direct communication connection with any second electronic device other than the first electronic device itself, or the first electronic device acts as a network management terminal in the direct communication connection established between the first electronic device and the second electronic device.

When the first electronic device has not established a direct communication connection with the second electronic device, or when the first electronic device has established a direct communication connection with the second electronic device as a network management terminal, the first electronic device should be able to establish a direct communication connection with the third electronic device. Under such a scenario, after obtaining the first command, the first electronic device may just display the illustrative information of the first electronic device.

As shown in FIG. 2, for electronic device A, since electronic device A serves as a network management terminal in the Wi-Fi direct connection established with electronic device B, if electronic device A obtains the first command, then electronic device A will present illustrative information containing device information of electronic device A. For example, a user operates in electronic device A to input a QR code in response to a request for presentation of Wi-Fi direct connection information, and electronic device A may display the QR code including device information required for its Wi-Fi direct connection.

Correspondingly, electronic device C may obtain the device information required to establish a Wi-Fi direct connection with electronic device A by directly scanning the QR code displayed by electronic device A, or obtaining the illustrative information displayed by electronic device A through other means, and thus can directly establish a Wi-Fi direct connection with electronic device A based on the device information.

It is to be noted that, in the disclosure, when the network device attributes of the first electronic device satisfy the target prerequisite, the first electronic device may also obtain the second device information of the second electronic device.

For example, in one embodiment, the first electronic device may obtain second device information of the second electronic device stored in the first electronic device, where the second device information is the device information based on which the first electronic device and the second electronic device established a direct communication connection based on a short-range communication protocol.

It is to be noted that before the first electronic device and the second electronic device establish a direct communication connection based on the short-range communication protocol, the first electronic device needs to obtain the second device information of the second electronic device. The first electronic device may then establish a direct communication connection with the second electronic device based on the second device information. Thereafter, the first electronic device may store the obtained second device information after establishing the direct communication connection with the second electronic device.

In one embodiment, considering that after the first electronic device establishes a direct communication connection with the second electronic device, the second electronic device may update its device name, the network name of the direct communication network it maintains, or the network password of the direct communication network, etc. Therefore, in order to improve the reliability of establishing a direct communication connection between the third electronic device and the second electronic device and reduce the risk of failing to establish a direct communication connection, in the present disclosure, the current second device information required for the second electronic device to establish a direct communication connection with other electronic devices may be obtained based on the direct communication connection established between the first electronic device and the second electronic device.

In one embodiment, the first electronic device needs to obtain the latest second device information of the second electronic device each time the two devices directly connect, so that the third electronic device may establish a direct communication connection with the second electronic device based on the latest second device information of the second electronic device. This then avoids a situation where the third electronic device is unable to join the direct communication connection group through the illustrative information displayed by the first electronic device due to the first electronic device being unable to update the second device information of the second electronic device locally in a timely manner.

The technical solution of the disclosure is further described hereinafter in conjunction with a method embodiment.

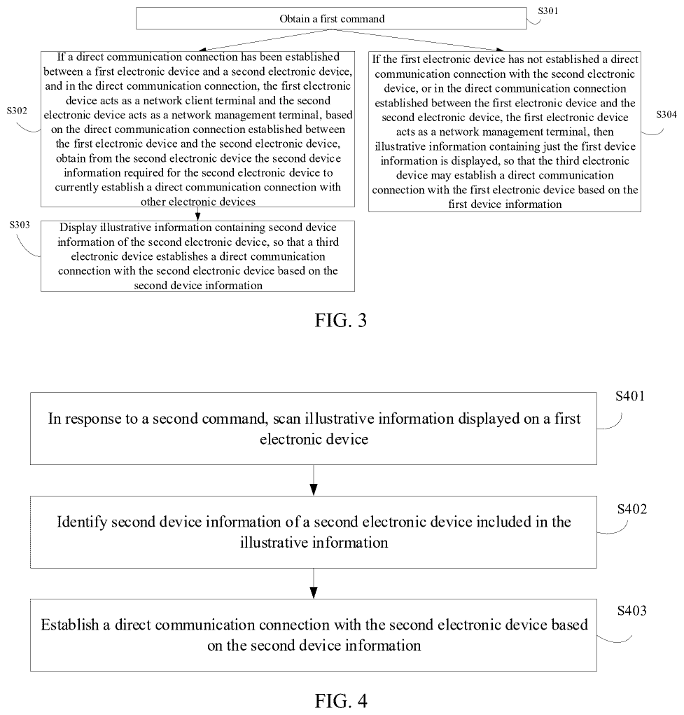

FIG. 3 illustrates a flowchart of a device connection method according to one embodiment of the present disclosure. The method of the illustrated embodiment is applied to a first electronic device. This method embodiment may include the following steps.
S301: Obtain a first command.

The first command is used to request display of first device information required to establish a direct communication connection with the first electronic device.

For example, the first command may be an “adding a new device” request for triggering to add a new device for direct communication connection. For example, still taking the Wi-Fi direct connection scenario as an example, a request for adding a new device for Wi-Fi direct connection may be detected.
S302: If a direct communication connection has been established between a first electronic device and a second electronic device, and in the direct communication connection the first electronic device acts as a network client terminal and the second electronic device acts as a network management terminal, based on the direct communication connection established between the first electronic device and the second electronic device, obtain from the second electronic device the second device information required for the second electronic device to currently establish a direct communication connection with other electronic devices.

It is to be noted that in the embodiment disclosed herein, the specific process of obtaining the current latest second device information from the second electronic device based on the direct communication connection established between the first electronic device and the second electronic device is merely for explanation purposes, but not for limitation. The other means of obtaining the second device information of the second electronic device are also possible and contemplated in the disclosure.
S303: Display illustrative information containing second device information of the second electronic device, so that the third electronic device establishes a direct communication connection with the second electronic device based on the second device information.

As can be seen from the previous description, when a direct communication connection is established between a first electronic device and a second electronic device, and the first electronic device acts as a network client terminal and the second electronic device acts as a network management terminal, the first electronic device no longer supports establishing a direct communication connection with other electronic devices, while the second electronic device still supports establishing a direct communication connection with other electronic devices.

Based on this, in order to enable the third electronic device to obtain the device information required to establish a direct communication connection through the first electronic device, the first electronic device will obtain the second device information of the second electronic device that has established a direct communication connection with the first electronic device and that serves as the network management terminal, then display the illustrative information containing the second device information.

Still taking the Wi-Fi direct connection scenario as an example, combined with FIG. 2, it can be seen that if the first electronic device is electronic device B, then because electronic device B has established a Wi-Fi direct connection with electronic device A, and electronic device B is a network client terminal in the Wi-Fi direct connection, electronic device B may no longer establish a Wi-Fi direct connection with other electronic devices.

According to the present disclosure, electronic device B may obtain device information such as the device name, the network name and password of the Wi-Fi direct network currently required for establishing the Wi-Fi direct connection in electronic device A based on the Wi-Fi direct connection with electronic device A. Accordingly, after electronic device B displays illustrative information containing the device information of electronic device A, electronic device C may obtain the device information of electronic device A from the illustrative information, thereby establishing a Wi-Fi direct connection with electronic device A, so that electronic device C is also added to the Wi-Fi direct connection group, as a network client terminal.

In the present disclosure, the illustrative information may include the first device information of the first electronic device and the second device information of the second electronic device at the same time. Optionally, in order to allow a user to understand that the illustrative information includes the device information of the second electronic device in addition to the first electronic device, the illustrative information may include a preset illustrative mark. Apparently, the illustrative information may indicate the priorities of the first device information and the second device information respectively, so that the third electronic device first establishes a direct communication connection based on the second device information with a higher priority, thereby avoiding a situation where the direct communication connection fails to be established. The specific details may refer to the earlier descriptions and will not be repeated here.

It is to be noted that in the disclosed embodiments, considering that the network device attributes of the first electronic device satisfy the target prerequisite, which actually means that the first electronic device can no longer establish a direct communication connection with the third electronic device, the illustrative information thus may just include the second device information of the second electronic device.

In the embodiment disclosed herein, the illustrative information may be displayed in the form of a list or a QR code to display device information as described above, which will not be repeated here.
S304: If the first electronic device has not established a direct communication connection with the second electronic device, or in the direct communication connection established between the first electronic device and the second electronic device, the first electronic device acts as a network management terminal, then illustrative information containing just the first device information is displayed, so that the third electronic device may establish a direct communication connection with the first electronic device based on the first device information.

Combined with the previous related description, it can be seen that, under the premise that the first electronic device has the function of establishing a direct communication connection, if the first electronic device has not established a direct communication connection with the second electronic device, then the first electronic device should be able to establish a direct communication connection with other electronic devices. Similarly, if the first electronic device has established a direct communication connection with the second electronic device, but in this direct communication connection, the first electronic device serves as the network management terminal, the first electronic device may still establish a direct communication connection with other electronic devices. Accordingly, the first electronic device may include just the first device information, required for the first electronic device to establish a direct communication connection, in the displayed information.

The device connection method of disclosure is described further from the perspective of the third electronic device.

FIG. 4 is a flowchart of a device connection method according to one embodiment of the present disclosure. The method of the illustrated embodiment is applied to a third electronic device, and may include the following steps.
S401: In response to a second command, scan illustrative information displayed on a first electronic device.

The illustrative information is generated when the network device attributes of the first electronic device satisfy the target prerequisite. The network device attributes of the first electronic device satisfying the target prerequisite indicate that a direct communication connection has been established between the first electronic device and the second electronic device.

In the disclosed embodiment, when the network device attributes of the first electronic device satisfy the target prerequisite, the illustrative information displayed by the first electronic device includes the second device information of the second electronic device. The specific process of the first electronic device displaying the illustrative information may refer to the relevant description of the previous embodiments, which will not be repeated here.
S402: Identify second device information of the second electronic device included in the illustrative information.

For example, if the displayed information is coded information such as a QR code or a barcode, the third electronic device needs to identify the second device information included in the coded information.

For another example, when the illustrative information is in text or other forms, after obtaining an image of the illustrative information by scanning, the second device information included in the illustrative information is identified from the image of the illustrative information.

Apparently, the illustrative information may also be in other forms. Accordingly, identifying the second device information from the illustrative information may also be implemented in other ways, which are not limited in the disclosure.

As can be seen from the previous embodiments, the illustrative information may just include the second device information of the second electronic device. Under such a scenario, the third electronic device may obtain the second device information by directly performing information recognition on the scanned illustrative information.

In one embodiment, the illustrative information may also include the first device information of the first electronic device and the second device information of the second electronic device. Under such a scenario, the third electronic device needs to identify the second device information from the illustrative information.

For example, the second device information in the illustrative information may also be associated with a high-priority indicator. Accordingly, the third electronic device may identify the device information associated with the high-priority indicator from the illustrative information to obtain the second device information.
S403: Establish a direct communication connection with the second electronic device based on the second device information.

For example, the second device information may include the device name of the second electronic device or the network name of the direct communication connection supported by the second electronic device, and may also include a password for establishing a direct communication connection with the second electronic device. The third electronic device searches for the device name or network name, and sends a direct communication connection request carrying the password to the second electronic device to request to establish a direct communication connection with the second electronic device. After the second electronic device agrees to the direct communication connection request of the third electronic device, a direct communication connection may be established between the second electronic device and the third electronic device.

Apparently, there may be other possible ways to establish a direct communication connection between the third electronic device and the second electronic device based on the second device information, which is not limited in the disclosure.

It is to be noted that if the illustrative information displayed by the first electronic device just includes the first device information of the first electronic device, then it means that the first electronic device supports establishing a direct communication connection with the third electronic device. Accordingly, the first electronic device scans the illustrative information and obtains the first device information. The third electronic device may establish a direct communication connection with the first electronic device based on the first device information.

From the above description, it can be seen that when the network device attributes of the first electronic device satisfy the target prerequisites, the illustrative information displayed by the first electronic device includes the second device information of the second electronic device that has established a direct communication connection with the first electronic device. Accordingly, even if the first electronic device can no longer establish a direct communication connection with the third electronic device, since the third electronic device may scan the illustrative information displayed by the first electronic device to obtain the second device information of the second electronic device, the third electronic device may still establish a direct communication connection with the second electronic device based on the second device information of the second electronic device, thereby joining the direct communication group where the first electronic device and the second electronic device are located. Accordingly, there is no need for the user to distinguish the network device attributes of the electronic devices that have established a direct communication connection, thereby avoiding a situation where the user cannot join the direct communication group due to incorrect device information for direct communication connection obtained by the electronic device, and reducing the complexity of establishing direct communication connections between electronic devices.

In another aspect, corresponding to the application of a device connection method applied to the first electronic device according to the disclosed embodiments, the present disclosure further provides a device connection apparatus.

FIG. 5 illustrates a schematic structural diagram of a device connection apparatus according to one embodiment of the present disclosure. The apparatus of the illustrated embodiment is applied to a first electronic device, and includes the following units.

An instruction acquiring unit 501, which is configured to obtain a first command, where the first command is used to request to display first device information required to establish a direct communication connection with a first electronic device.

A first information display unit 502, which is configured to determine, when the network device attributes of the first electronic device satisfy the target prerequisite, to display illustrative information containing second device information of the second electronic device, so that the third electronic device may establish a direct communication connection with the second electronic device based on the second device information. The network device attributes satisfying the target prerequisite indicate that the first electronic device has established a direct communication connection with the second electronic device.

In one embodiment, the first information display unit determines that the network device attributes of the first electronic device satisfy the target prerequisites specifically as follows: in a direct communication connection established between the first electronic device and the second electronic device, the first electronic device acts as a network client terminal and the second electronic device acts as a network management terminal.

In one embodiment, the device connection apparatus further includes: a first information acquiring unit, which is configured to obtain second device information of the second electronic device stored in the first electronic device, where the second device information is device information based on which the first electronic device and the second electronic device have established a direct communication connection based on a short-range communication protocol.

In one embodiment, the device connection apparatus further includes: a second information acquiring unit, which is configured to obtain, from the second electronic device, second device information currently required by the second electronic device to establish a direct communication connection with other electronic devices based on the direct communication connection established between the first electronic device and the second electronic device.

In one embodiment, the device connection apparatus further includes: a second information display unit, which is configured to display illustrative information containing just the first device information if the network device attributes do not satisfy the target prerequisite.

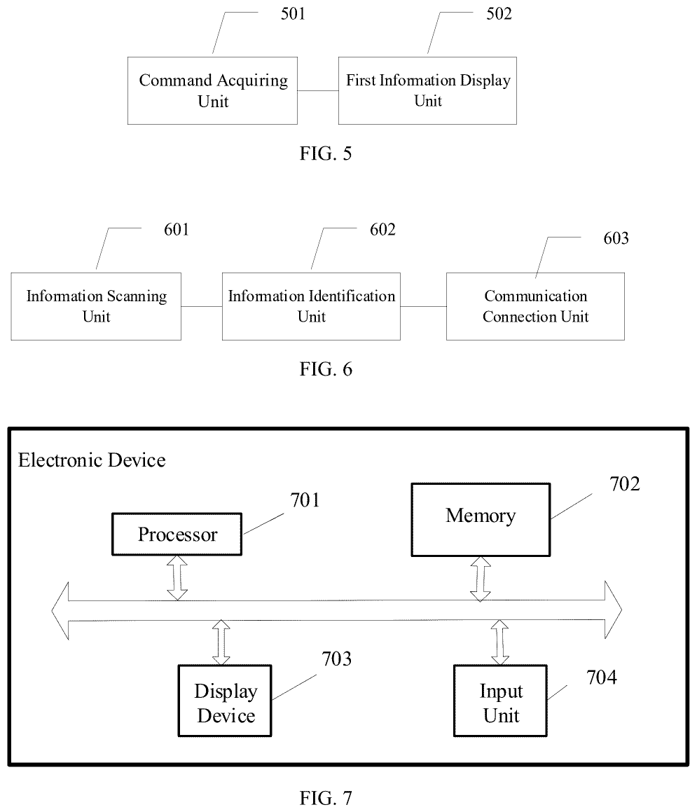

In another aspect, corresponding to the application of a device connection method applied to a third electronic device according to the disclosed embodiments, the present disclosure further provides another device connection apparatus. FIG. 6 illustrates a schematic diagram of a composition architecture of another device connection apparatus according to one embodiment of the present disclosure. The apparatus in the illustrated embodiment may include the following units.

A information scanning unit 601, which is configured to scan the illustrative information displayed on the first electronic device in response to the second command, where the illustrative information is generated when the network device attributes of the first electronic device satisfy the target prerequisite. The network device attributes of the first electronic device satisfying the target prerequisites indicate that a direct communication connection has been established between the first electronic device and the second electronic device.

An information identification unit 602, which is configured to identify the second device information of the second electronic device included in the illustrative information.

A communication connection unit 603, which is configured to establish a direct communication connection with the second electronic device based on the second device information.

In another aspect, the disclosure further provides an electronic device. FIG. 7 illustrates a schematic diagram of a composition architecture of an electronic device according to one embodiment of the present disclosure. The electronic device in the illustrated embodiment may include: a processor 701, a memory 702, and a display device 703.

The processor is configured to obtain a first command, where the first command is used to request the display of first device information required for establishing a direct communication connection with the first electronic device. The processor then determines that the network device attributes of the first electronic device satisfy the target prerequisite, and thus displays the illustrative information containing the second device information of the second electronic device through the display device, so that the third electronic device establishes a direct communication connection with the second electronic device based on the second device information. The network device attributes satisfying the target prerequisite indicate that the first electronic device and the second electronic device have established a direct communication connection.

The memory 702 is configured to store programs required by the processor to perform operations.

It is to be noted that the processor may also be configured to execute other related operations on the first electronic device side in the device connection method mentioned in the previous embodiments.

Further, the processor may also be configured to execute related operations on the third electronic device side in the device connection method mentioned in the previous embodiments, which will not be described in detail here.

It is to be noted that the electronic device may further include an input unit 704.

Apparently, the electronic device may also have more or fewer components than those illustrated in FIG. 7, which is not limited in the disclosure.

In another aspect, the disclosure also provides a computer program product, including computer instructions, which are stored in a computer-readable storage medium. When the computer program product is run on an electronic device, the computer program product is configured to execute the device connection methods described elsewhere herein.

In another aspect, the disclosure further provides a computer-readable storage medium, which stores at least one instruction, at least one program, a code set, or an instruction set. The at least one instruction, the at least one program, the code set, or the instruction set is loaded and executed by a processor to implement the device connection methods described elsewhere herein.

It is to be noted that in the present disclosure, the terms “first”, “second”, “third”, “fourth”, etc., (if there are any) in the specification and claims and the accompanying drawings are used to distinguish similar parts, and are not necessarily used to describe a specific order or sequence. It is to be noted that the numbers used in such a way may be interchanged where appropriate, so that the embodiments of the present disclosure described herein may be implemented in an order other than that illustrated herein.

It should be noted that each embodiment in this specification is described in a progressive manner, and each embodiment focuses on the differences from other embodiments. The same and similar parts between the embodiments may refer to each other. Meanwhile, the features described in each embodiment in this specification may be replaced or combined with each other, so that a person skilled in the art may implement or enable the disclosed technical solution. For device embodiments, since they are basically similar to method embodiments, the description is relatively simple, and the relevant content may refer to the specific description of the method embodiments.

Further, it should be noted that, in this specification, relational terms such as first and second, etc., are just used to distinguish one entity or operation from another entity or operation, and do not necessarily require or imply any such actual relationship or order between these entities or operations. Moreover, the terms “include”, “comprise” or any other variants thereof are intended to cover non-exclusive inclusion, so that a process, method, article, or device including a series of elements includes not only those elements, but also other elements not explicitly listed, or also includes elements inherent to such process, method, article or device. In the absence of further restrictions, the elements defined by the sentence “comprise a . . . ” do not exclude the presence of other identical elements in the process, method, article, or device including the elements.

The above description of the disclosed embodiments enables those skilled in the art to implement or use the technical solution disclosed herein. Various modifications to these embodiments will be apparent to those skilled in the art, and the general principles defined herein may be implemented in other embodiments without departing from the spirit or scope of the present disclosure. Therefore, the disclosure will not be limited to the embodiments shown herein, but will conform to the widest scope consistent with the principles and novel features disclosed herein.

The above are just some specific embodiments of the present disclosure. It should be noted that for a person skilled in the art, specific improvements and modifications may be made without departing from the principles of the disclosure, which should also fall within the scope of protection of the present disclosure.

What is claimed is:

1. A device connection method, applied to a first electronic device, comprising:
obtaining a first command, wherein the first command is used to request display of first device information required to establish a direct communication connection with the first electronic device; and
determining that network device attributes of the first electronic device satisfy a target prerequisite, and displaying illustrative information containing second device information of a second electronic device, so that a third electronic device establishes a direct communication connection with the second electronic device based on the second device information, wherein the network device satisfying the target prerequisite indicates that the first electronic device has established a direct communication connection with the second electronic device.

2. The device connection method according to claim 1, wherein the network device attributes of the first electronic device satisfying the target prerequisite include that, in the direct communication connection established between the first electronic device and the second electronic device, the first electronic device serves as a network client terminal and the second electronic device serves as a network management terminal.

3. The device connection method according to claim 1, further comprising:
obtaining the second device information of the second electronic device stored in the first electronic device, wherein the second device information is device information based on which the direct communication connection is established between the first electronic device and the second electronic device based on a short-distance communication protocol.

4. The device connection method according to claim 1, further comprising:
based on the direct communication connection established between the first electronic device and the second electronic device, obtaining, from the second electronic device, second device information currently required by the second electronic device to establish a direct communication connection with other electronic devices.

5. The device connection method according to claim 1, further comprising:
when the network device attributes do not satisfy the target prerequisite, displaying illustrative information containing just the first device information.

6. The device connection method according to claim 1, wherein the second device information in the illustrative information is encoded information, and the illustrative information includes a preset illustrative mark for indicating that the illustrative information includes the second device information.

7. The device connection method according to claim 1, wherein the illustrative information includes first device information of the first electronic device and the second device information of the second electronic device; and the second device information has a high-priority indicator.

8. A device connection method, comprising:
in response to a second command, scanning illustrative information displayed on a first electronic device;
identifying second device information of a second electronic device included in the illustrative information; and
based on the second device information, establishing a direct communication connection with the second electronic device,
wherein the illustrative information is generated when network device attributes of the first electronic device satisfy a target prerequisite, and the network device attributes of the first electronic device satisfying the target prerequisite indicate that a direct communication connection has been established between the first electronic device and the second electronic device.

9. The device connection method according to claim 8, wherein:
the illustrative information includes first device information of the first electronic device and the second device information of the second electronic device; and
identifying the second device information of the second electronic device included in the illustrative information includes identifying the second device information from the illustrative information.

10. The device connection method according to claim 9, wherein identifying the second device information of the second electronic device included in the illustrative information comprises:
identifying device information associated with a high-priority indicator from the illustrative information to obtain the second device information.

11. The device connection method according to claim 8, wherein the network device attributes of the first electronic device satisfying the target prerequisite include that, in the direct communication connection established between the first electronic device and the second electronic device, the first electronic device serves as a network client terminal and the second electronic device serves as a network management terminal.

12. The device connection method according to claim 8, wherein the second device information in the illustrative information is encoded information.

13. The device connection method according to claim 12, wherein identifying the second device information of the second electronic device includes scanning the encoded information to identity the second device information.

14. The device connection method according to claim 8, wherein the illustrative information includes a preset illustrative mark for indicating that the illustrative information includes the second device information.

15. An electronic device comprising: at least one processor, a memory, and a display device, wherein:
the at least one processor is configured to:
obtain a first command, wherein the first command is used to request display of first device information required for establishing a direct communication connection with a first electronic device;
determine that network device attributes of the first electronic device satisfy a target prerequisite; and
display illustrative information containing second device information of a second electronic device through the display device, so that a third electronic device establishes a direct communication connection with the second electronic device based on the second device information, wherein the network device attributes satisfying the target prerequisite indicates that the first electronic device and the second electronic device have established a direct communication connection; and
the memory is configured to store programs required for the at least one processor to perform operations.

16. The electronic device according to claim 15, wherein the network device attributes of the first electronic device satisfying the target prerequisite include that, in the direct communication connection established between the first electronic device and the second electronic device, the first electronic device serves as a network client terminal and the second electronic device serves as a network management terminal.

17. The electronic device according to claim 15, wherein the at least one processor is configured to:
obtain the second device information of the second electronic device stored in the first electronic device, wherein the second device information is device information based on which the direct communication connection is established between the first electronic device and the second electronic device based on a short-distance communication protocol.

18. The electronic device according to claim 15, wherein the at least one processor is configured to:
based on the direct communication connection established between the first electronic device and the second electronic device, obtain, from the second electronic device, second device information currently required by the second electronic device to establish a direct communication connection with other electronic devices.

19. The electronic device according to claim 15, wherein the at least one processor is configured to:
when the network device attributes do not satisfy the target prerequisite, display illustrative information containing just the first device information.

20. The electronic device according to claim 15, wherein the second device information in the illustrative information is encoded information, and the illustrative information includes a preset illustrative mark for indicating that the illustrative information includes the second device information.
